(19) United States
(12) Patent Application Publication
(10) Pub. No.: US 2009/0068421 A1
(43) Pub. Date: Mar. 12, 2009

(54) GRAVURE PRINTING ROLL AND MANUFACTURING METHOD THEREOF

(75) Inventor: Tsutomu Sato, Chiba (JP)

Correspondence Address: MARGER JOHNSON & MCCOLLOM, P.C., 210 SW MORRISON STREET, SUITE 400, PORTLAND, OR, 97204, US

(73) Assignee: THINK LABORATORY CO., LTD., Chiba (JP)

(21) Appl. No.: 11/994,971

(22) PCT Filed: Jul. 19, 2006
(86) PCT No.: PCT/JP2006/314251

§ 371 Date: Jan. 7, 2008

(30) Foreign Application Priority Data
Jul. 25, 2005 (JP) 2005-214996
Jul. 19, 2006 (JP) PCT/JP2006/314251

(51) Int. Cl. B32B 3/10; B05D 5/04; B05D 3/14; B44C 1/22

(52) U.S. Cl. 428/201; 427/270; 427/532; 216/83

(57) ABSTRACT

The present invention provides a novel gravure printing roll which includes a surface reinforcing coating layer having no toxicity and no possibility of causing pollution, and which has excellent printing resistance, and a manufacturing method thereof. The gravure printing roll includes: a plate base material; a copper plating layer formed on a surface of the plate base material and having multiple gravure cells formed thereon; and a silicon dioxide film which covers a surface of the copper plating layer, in which the silicon dioxide film is formed by using a perhydropolysilazane solution. The copper plating layer has a thickness of from 50 to 200 μm, the gravure cell has a depth of from 5 to 150 μm, and the silicon dioxide film has a thickness of from 0.1 to 5 μm, preferably 0.1 to 3 μm, and more preferably 0.1 to 1 μm.

### TECHNICAL FIELD

The present invention relates to a gravure printing roll including a surface reinforcing coating layer having sufficient strength without using chromium plating, and to a manufacturing method thereof. More specifically, the present invention relates to a gravure printing roll including a silicon dioxide layer as a surface reinforcing coating layer for substituting a chromium layer, and to a manufacturing method thereof.

### BACKGROUND ART

In gravure printing, fine depressions (gravure cells) are formed in a plate base material according to plate making information, and ink is filled into the gravure cells to be transferred to a material to be printed. In the ordinary gravure printing roll, a copper plating layer (plate material) for forming a printing plate is formed on a surface of a metal hollow roll made of aluminum or iron, or carbon fiber-reinforced plastic (CFRP) hollow roll, multiple fine depressions (gravure cells) are formed in the copper plating layer by etching according to plate making information, and then a hard chromium layer is formed as a surface reinforcing coating layer by chromium plating to increase the printing resistance of the gravure printing roll, and thus completing plate making (manufacture of a printing plate). However, as hexavalent chromium having high toxicity is used in a step of chromium plating, extra cost is required to maintain work safety, and chromium plating has a pollution problem. Therefore, it is a current situation that the appearance of a surface reinforcing coating layer as a substitute for the chromium layer is desired.

Meanwhile, there is known a method of forming a silicon dioxide film by applying a perhydropolysilazane solution to a substrate made of a metal or a resin and heating the coating layer in the air or an atmosphere containing steam (Patent Documents 1 to 4). There are also known technologies for covering protective films for an interior and exterior of a vehicle such as an automobile, deterioration prevention films for metal ornaments such as spectacle frames, deterioration and stain preventing films for an interior and exterior of a building, and substrates such as metal members, plastic members, ceramic members, solar cell substrates, optical waveguide substrates and liquid crystal substrates with this hard stiff silicon dioxide (SiO₂) film (Patent Documents 1 to 4). However, for the manufacture of a gravure printing roll (gravure cylinder), a technology for forming a silicon dioxide film on a copper plating layer by using the perhydropolysilazane solution and using the silicon dioxide film as a surface reinforcing coating layer for substituting a chromium layer has not been developed yet.

### Patent Document 1: JP 2001-089126 A

### Patent Document 2: JP 2002-105676 A

### Patent Document 3: JP 2003-197611 A

### Patent Document 4: JP 2003-336010 A

### DISCLOSURE OF THE INVENTION

### Problem to be solved by the Invention

In view of the above-mentioned problems of the prior art, the inventor of the present invention has kept on with his intensive studies on a surface reinforcing coating layer for substituting a chromium layer, and has found that a surface reinforcing coating layer, which is as strong as a chromium layer and has no toxicity and no possibility of causing pollution can be obtained by forming a silicon dioxide film using a perhydropolysilazane solution. The present invention has been accomplished based on this finding.

It is an object of the present invention to provide a novel gravure printing roll which includes a surface reinforcing coating layer having no toxicity and no possibility of causing pollution, and which has excellent printing resistance, and a manufacturing method thereof.

### Means for Solving the Problem

To attain the above-mentioned object, a gravure printing roll of the present invention comprises: a plate base material; a copper plating layer formed on a surface of the plate base material and having multiple gravure cells formed thereon; and a silicon dioxide film which covers a surface of the copper plating layer, in which the silicon dioxide film is formed by using a perhydropolysilazane solution. As the plate base material may be used a metal hollow roll made of iron or aluminum, or a carbon fiber reinforced plastic (CFRP) hollow roll.

In the gravure printing roll of the present invention, the thickness of the copper plating layer is 50 to 200 μm, the depth of the gravure cells is 5 to 150 μm, and the thickness of the silicon dioxide film is 0.1 to 5 μm, preferably 0.1 to 3 μm, and more preferably 0.1 to 1 μm.

A method of manufacturing a gravure printing roll of the present invention includes the steps of: preparing a plate base material; forming a copper plating layer on a surface of the plate base material; forming multiple gravure cells on a surface of the copper plating layer; and forming a silicon dioxide film on the surface of the copper plating layer having gravure cells formed therein, wherein the silicon dioxide film is formed by using a perhydropolysilazane solution.

A known solvent may be used as the solvent, which dissolves the perhydropolysilazane. Examples of the solvent include benzene, toluene, xylene, ether, THF, methylene chloride, and carbon tetrahydride; and anisole, decalin, cyclohexene, methyl cyclohexane, ethyl cyclohexane, limonene, hexane, octane, nonane, decane, mixture of alkanes having 8 to 11 carbon atoms, a mixture of aromatic hydrocarbons having 18 to 11 carbon atoms, a mixture of aliphatic and alicyclic hydrocarbons which contain 5 or more to 25 or less wt % of an aromatic hydrocarbon having 8 or more carbon atoms, solvesso, diisopropyl ether, methyl t-butyl ether, decahydronaphthalene, and dibutyl ether, which are disclosed by Patent Document 3.

Although the perhydropolysilazane solution prepared by dissolving perhydropolysilazane in the solvent is directly converted into silicon dioxide or by a heating process with superheated steam, a catalyst is preferably used to increase the reaction rate, shorten the reaction time, reduce the reaction temperature and improve the adhesion of the formed silicon dioxide film. A known catalyst such as an amine or palladium may be used. Specific examples of the catalyst include organic amines such as primary to tertiary linear aliphatic amines having 1 to 3 alkyl groups with 1 to 5 carbon atoms, primary to tertiary aromatic amines having 1 to 3 phenyl groups, pyridine and alicyclic amines obtained by substituting the nucleus of pyridine with an alkyl group such as methyl or ethyl as disclosed by the Patent Document 1. More preferred are diethylamine, triethylamine, monobutylamine, monopropylamine, and dipropylamine. The catalyst may be added to the perhydropolysilazane solution in advance or may be contained in a gaseous state into an atmosphere for heating with superheated steam.

In the method of manufacturing a gravure printing roll of the present invention, the thickness of the copper plating layer is 50 to 200 μm, the depth of the gravure cells is 5 to 150 μm, and the thickness of the silicon dioxide film is 0.1 to 5 μm, preferably 0.1 to 3 μm, and more preferably 0.1 to 1 μm.

Preferably, the step of forming a silicon dioxide film includes: a forming process for forming a coating film involving applying the perhydropolysilazane solution to the surface of the copper plating layer to form the coating film having a predetermined thickness; and a heating process for forming a film involving heating the coating film applied with the perhydropolysilazane solution with superheated steam for a predetermined period of time to form a silicon dioxide film having a predetermined hardness.

Although the thickness of the coating film of the perhydropolysilazane solution changes according to the concentration of the perhydropolysilazane solution, the thickness of the silicon dioxide film after the heating process for forming a film is 0.1 to 5 μm, preferably 0.1 to 3 μm, and more preferably 0.1 to 1 μm. For example, when the concentration of the perhydropolysilazane solution is 20%, the thickness of the coating film of the perhydropolysilazane solution may be about 5 times larger than the thickness of the target silicon dioxide film. The period of time for heating, which changes according to the temperature of the superheated steam, is sufficient to be about 5 minutes to 1 hour. The hardness of the formed silicon dioxide film is about 800 to 3,000 in terms of Vickers hardness.

Preferably, the method of manufacturing a gravure printing roll further includes a step of washing a surface of the silicon dioxide film formed by the heating process with cold water or hot water. The quality of the silicon dioxide film can be improved by washing the surface of the silicon dioxide film formed with cold water or hot water. Normal temperature water may be used as the cold water and water heated at about 40 to 100° C. may be used as the hot water. The washing time is sufficient to be about 30 seconds to 10 minutes.

The method of applying the perhydropolysilazane may include spray coating, ink jet coating, meniscus coating, fountain coating, dip coating, rotational coating, roll coating, wire bar coating, air knife coating, blade coating, or curtain coating.

The temperature of the superheated steam is higher than 100° C., and preferably 300° C. or lower. When the material of the hollow roll is aluminum, heating at a temperature higher than 200° C. causes the deterioration of the hollow roll. Therefore, the temperature is more preferably higher than 100° C. and 200° C. or lower.

The gravure cells are formed by etching or electronic engraving, out of which etching is preferred. In the case of etching, after a photosensitive liquid is applied to the body surface (copper plating layer) of the plate base material and burned directly, the coating film is etched to form the gravure cells. In the case of electronic engraving, the gravure cells are engraved on the surface of the copper plating layer of the plate base material by moving a diamond engraving needle mechanically based on a digital signal.

### EFFECT OF THE INVENTION

According to the present invention, the chromium plating step can be omitted by using a silicon dioxide film formed from a perhydropolysilazane solution as a surface reinforcing coating layer. As a result, the use of hexavalent chromium having high toxicity is eliminated, extra cost for securing work safety is not necessary, there is no risk of causing pollution, and the silicon dioxide film is as strong as a chromium layer and has excellent printing resistance.

### BRIEF DESCRIPTION OF THE DRAWINGS

FIG. 1 is a diagram showing a process of manufacturing a gravure printing roll of the present invention, in which the part (a) is a sectional view of an entire plate base material, the part (b) is a partially enlarged sectional view showing that a copper plating layer is formed on a surface of the plate base material, the part (c) is a partially enlarged sectional view showing that gravure cells are formed in the copper plating layer of the plate base material, the part (d) is a partially enlarged view showing that a perhydropolysilazane coating layer is formed on the surface of the copper plating layer of the plate base material, and the part (e) is a partially enlarged view showing that the perhydropolysilazane coating layer is converted into a silicon dioxide film by heating with superheated steam.

FIG. 2 is a flow chart showing a process of manufacturing a gravure printing roll of the present invention.

### DESCRIPTION OF SYMBOLS

10: a plate base material, 10a: a gravure printing roll, 12: a copper plating layer, 14: a gravure cell, 16: a perhydropolysilazane coating layer, 18: a silicon dioxide film

### BEST MODE FOR CARRYING OUT THE INVENTION

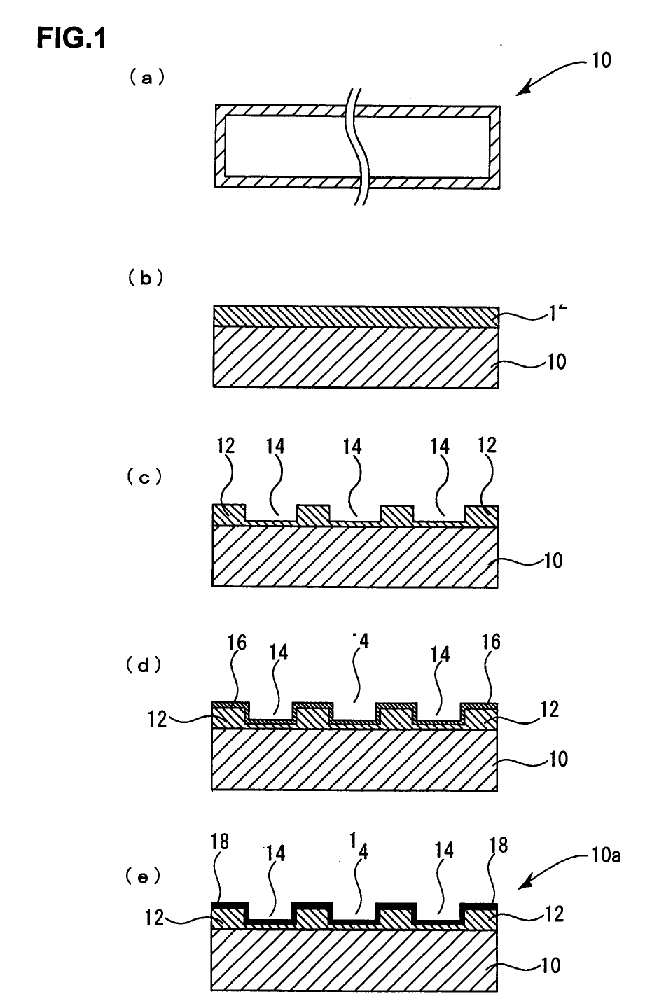

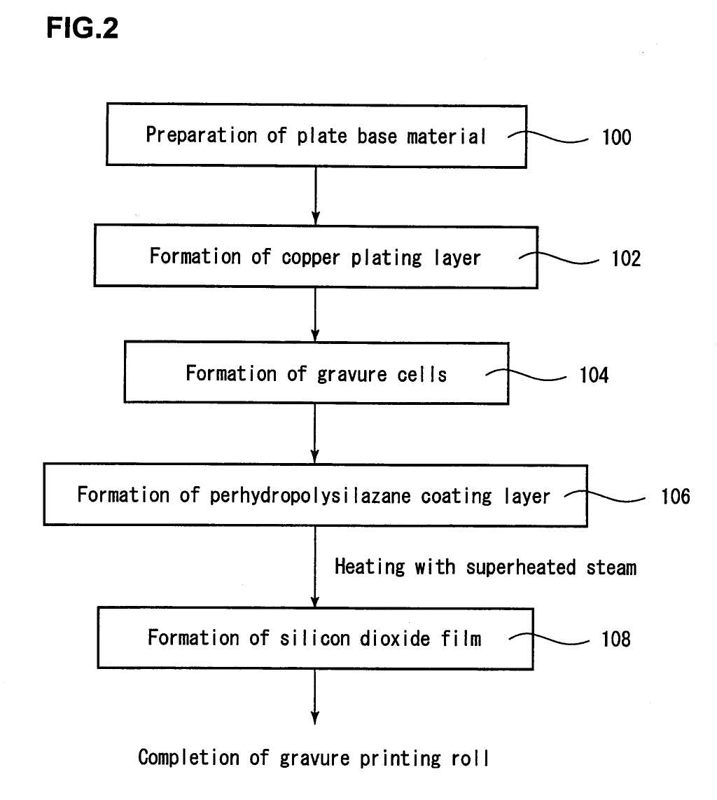

An embodiment of the present invention will be described with reference to FIG. 1 and FIG. 2. It is needless to say that this embodiment is illustrative and can be modified in various ways without departing from a technical idea of the present invention.

The method of the present invention will be described with reference to FIG. 1 and FIG. 2. In FIG. 1(a), reference numeral 10 denotes a plate base material, which is a hollow roll made of aluminum, iron, or CFRP (step 100 in FIG. 2). A copper plating layer 12 is formed on a surface of the plate base material 10 by copper plating (step 102 in FIG. 2).

Multiple fine depressions (gravure cells) 14 are formed on a surface of the copper plating layer 12 (step 104 of FIG. 2). To form the gravure cells 14, a known method such as etching (after a photosensitive liquid is applied to the plate body surface, that is, the copper plating layer and directly burned, the coating film is etched to form gravure cells 14) or electronic engraving (a diamond engraving needle is mechanically moved to engrave gravure cells 14 on the surface of the copper plating layer based on a digital signal) may be employed. Etching is preferred.

A perhydropolysilazane coating layer 16 is formed on the surface of the copper plating layer 12 (including the gravure cells 14) having the gravure cells 14 (step 106 of FIG. 2). To form the perhydropolysilazane coating layer 16, the perhydropolysilazane solution should be applied by spray coating, ink jet coating, meniscus coating, fountain coating, dip coating, rotational coating, roll coating, wire bar coating, air knife coating, blade coating or curtain coating.

A known solvent may be used as the solvent, which dissolves the perhydropolysilazane. Examples of the solvent include benzene, toluene, xylene, ether, THF, methylene chloride, and carbon tetrahydride; and anisole, decalin, cyclohexene, methyl cyclohexane, ethyl cyclohexane, limonene, hexane, octane, nonane, decane, mixture of alkanes having 8 to 11 carbon atoms, a mixture of aromatic hydrocarbons having 18 to 11 carbon atoms, a mixture of aliphatic and alicyclic hydrocarbons which contain 5 or more to 25 or less wt % of an aromatic hydrocarbon having 8 or more carbon atoms, solvesso, diisopropyl ether, methyl t-butyl ether, decahydronaphthalene, and dibutyl ether, which are disclosed by Patent Document 3.

Although the perhydropolysilazane solution prepared by dissolving perhydropolysilazane in the solvent is directly converted into silicon dioxide or by a heating process with superheated steam, a catalyst is preferably used to increase the reaction rate, shorten the reaction time, reduce the reaction temperature and improve the adhesion of the formed silicon dioxide film. A known catalyst such as an amine or palladium may be used. Specific examples of the catalyst include organic amines such as primary to tertiary linear aliphatic amines having 1 to 3 alkyl groups with 1 to 5 carbon atoms, primary to tertiary aromatic amines having 1 to 3 phenyl groups, pyridine and alicyclic amines obtained by substituting the nucleus of pyridine with an alkyl group such as methyl or ethyl as disclosed by the Patent Document 1. More preferred are diethylamine, triethylamine, monobutylamine, monopropylamine, and dipropylamine. The catalyst may be added to the perhydropolysilazane solution in advance or may be contained in a gaseous state into an atmosphere for heating with superheated steam.

Subsequently, a silicon dioxide film 18 is formed by heating the perhydropolysilazane coating layer 16 with superheated steam (step 108 of FIG. 2).

A gravure printing roll 10a having no toxicity, no risk of causing pollution, and excellent printing resistance can be obtained by forming the silicon dioxide film 18 and using it as a surface reinforcing coating layer.

The thickness of the copper plating layer is preferably 50 to 200 μm, the depth of the gravure cells is preferably 5 to 150 μm, and the thickness of the silicon dioxide film is preferably 0.1 to 5 μm, more preferably 0.1 to 3 μm, and most preferably 0.1 to 1 μm.

The temperature of the superheated steam is higher than 100° C., preferably 300° C. or lower. When the plate base material is made of aluminum, heating at a temperature higher than 200° C. causes the deterioration of the plate base material. Therefore, the temperature is preferably higher than 100° C. and 200° C. or lower.

### EXAMPLE

The present invention is further described in detail by way of example. However, it should be noted that the present invention should not be construed as limiting.

### Example 1

The following copper layer was formed and etched by using Boomerang Line (a gravure printing roll manufacturing machine, manufactured by Think Laboratory Co., Ltd.). First, a gravure cylinder (an aluminum hollow roll) having a circumference of 600 mm and a length of 1,100 mm was set in a plating tank, an anode chamber was brought up to a position 20 mm away from the hollow roll by an automatic slide apparatus using a computer system, and a plating liquid was overflown to submerge the entire hollow roll so as to form a copper plating layer having a thickness of 80 μm at 18 A/dm² and 6.0 V. The plating time was 20 minutes, no bumps and pits were formed on the plating surface, and a uniform copper plating layer was obtained. The surface of this copper plating layer was polished with a 4H polishing machine (manufactured by Think laboratory Co., Ltd.) for 12 minutes to make the surface of the copper plating layer uniform.

A photosensitive film (thermal resist: TSER-2104E4) was formed on the formed copper plating layer with a coater (fountain coater) and dried. When the thickness of the obtained photosensitive film was measured with a film thickness meter (F20 manufactured by Filmetrics, Inc, and marketed by Matsushita Techno Trading Co., Ltd.), it was 4 μm. Then, an image was exposed to a laser beam and developed. The laser exposure was carried out with Laser Stream FX for 5 minutes/m²/10 W to form a predetermined pattern. The development was carried out by using a TLD developer (manufactured by Think Laboratory Co., Ltd.) at a developer dilution rate of 1:7 (undiluted solution:water) and 24° C. for 60 seconds to form a predetermined pattern. This pattern was dried (burning) to form a resist image.

Further, cylinder etching was carried out to engrave an image of gravure cells, and then the resist image was removed to form a printing plate. At this point, a cylinder was manufactured by setting the depth of the gravure cells to 12 μm. The etching was carried out by spraying at a copper concentration of 60 g/l, a hydrochloric acid concentration of 35 g/l, and a temperature of 37° C. for a time of 70 seconds.

The hexavalent chromium substitute film of the present invention was formed as follows. A 20% dibutyl ether solution of perhydropolysilazane (product name: Aquamica NL120A-20, “Aquamica” is the registered trademark of AZ Electronic Materials Co., Ltd.) was applied to the cylinder forming a printing plate by HVLP spray coating. The thickness of the coating film uniformly formed on the cylinder was 0.8 μm. The cylinder coated with perhydropolysilazane was heated with superheated steam (200° C./100% RH) for 30 minutes. The gravure printing roll (gravure cylinder) was thus completed. A silicon dioxide film having a thickness of 0.2 μm was formed on the surface of the cylinder. When the Vickers hardness of the film was measured, it was 2,500.

Subsequently, a printing test (printing speed: 120 m/min) was conducted on the obtained gravure cylinder by using cyanide ink (Zahn cup viscosity of 18 seconds, Super Ramipure Indigo 800PR-5 aqueous ink, manufactured by SAKATA INX CORPORATION) as printing ink and OPP (Oriented Polypropylene Film: biaxially oriented polypropylene film). The obtained printed material had no fogging, and printing could be made up to a length of 50,000 m. The accuracy of the pattern did not change. There was no problem with the adhesion of the silicon dioxide film to the etched copper plated cylinder. Gradation from the highlighted portion to the shadow portion of the gravure cylinder of the present invention did not differ from that of a chromium plated gravure cylinder manufactured in accordance with a commonly used method. Accordingly, it is judged that there was no problem with ink transferability. As a result, it was confirmed that the silicon dioxide film derived from perhydropolysilazane has performance equivalent to that of a conventional chromium layer and can be used as a substitute for the chromium layer satisfactorily.

1. A gravure printing roll, comprising:
a plate base material;
a copper plating layer formed on a surface of the plate base material and having multiple gravure cells formed thereon; and
a silicon dioxide film, which covers a surface of the copper plating layer,
wherein the silicon dioxide film is formed by using a perhydropolysilazane solution.

2. The gravure printing roll according to claim 1, wherein the copper plating layer has a thickness of from 50 to 200 μm, the gravure cell has a depth of from 5 to 150 μm, and the silicon dioxide film has a thickness of from 0.1 to 5 μm.

3. A method of manufacturing a gravure printing roll, comprising the steps of:
preparing a plate base material;
forming a copper plating layer on a surface of the plate base material;
forming multiple gravure cells on a surface of the copper plating layer; and
forming a silicon dioxide film on the surface of the copper plating layer having gravure cells formed therein, wherein the silicon dioxide film is formed by using a perhydropolysilazane solution.

4. The method of manufacturing a gravure printing roll according to claim 3, wherein the copper plating layer has a thickness of from 50 to 200 μm, the gravure cell has a depth of from 5 to 150 μm, and the silicon dioxide film has a thickness of from 0.1 to 5 μm.

5. The method of manufacturing a gravure printing roll according to claim 3, wherein the step of forming a silicon dioxide film comprises:
a forming process for forming a gravure printing roll involving applying the perhydropolysilazane solution to the surface of the copper plating layer to form the coating film having a predetermined thickness; and
a heating process for forming a film involving heating the coating film applied with the perhydropolysilazane solution with superheated steam for a predetermined period of time to form a silicon dioxide film having a predetermined hardness.

6. The method of manufacturing a gravure printing roll according to claim 5, further comprising a step of washing a surface of the silicon dioxide film formed by the heating process with cold water or hot water.

7. The method of manufacturing a gravure printing roll according to claim 3, wherein the gravure cells are formed by etching or electronic engraving.
